(19) United States
(12) Patent Application Publication
(10) Pub. No.: US 2023/0025851 A1
(43) Pub. Date: Jan. 26, 2023

(54) IMAGING LENS

(71) Applicant: Panasonic Intellectual Property Management Co., Ltd., Osaka (JP)

(72) Inventor: Yasutaka MATSUMOTO, Tokyo (JP)

(21) Appl. No.: 17/831,022

(22) Filed: Jun. 2, 2022

(30) Foreign Application Priority Data
Jul. 16, 2021 (JP) 2021-118131

(51) Int. Cl. G02F 1/1335; H04N 5/225; G02B 5/02; G02B 7/02; G02B 1/11

(52) U.S. Cl. CPC G02F 1/133504; H04N 5/2254; G02B 5/021; G02B 7/021; G02B 1/11

(57) ABSTRACT

An imaging lens includes a lens barrel, and a lens installed in a lens barrel. At least an edge surface of an edge portion on an incident surface side of the lens is formed of a diffusing surface, the edge portion being formed outside an effective diameter of the lens, to surround the lens.

### CROSS-REFERENCE TO RELATED APPLICATIONS

This application is based upon and claims the benefit of priority from Japanese Patent Application No. 2021-118131, filed on Jul. 16, 2021, the entire contents of which are incorporated herein by reference.

### FIELD

The present disclosure relates to an imaging lens.

### BACKGROUND

In recent years, various types of driving assistance systems using cameras have been mounted on vehicles. These driving assistance systems provide, for example, an image of a vehicle periphery captured by a camera to a driver as a substitute for an inner mirror or a door mirror. In addition, by detecting road linearity around the vehicle and information on an obstacle around the vehicle using the image captured by the camera, surrounding information is acquired for performing automatic vehicle driving. Since the image captured by the camera is used for the purpose of substituting human vision, the image is required to have a good quality with high contrast. For example, it is required that flares and ghosts, which cause deterioration in image quality, hardly occur. Flare and ghost occur when unnecessary reflection generated inside the lens due to strong backlight entering the lens becomes stray light and reaches an imaging element.

For example, in JP 2020-106725 A, a light shielding plate is installed in a lens barrel enclosing a lens unit to prevent occurrence of unnecessary reflection inside the lens.

However, since a lens and a light shielding plate are separate members, there is a problem that it takes time and effort to accurately install the light shielding plate in a direction orthogonal to an optical axis of the lens when assembling the lens.

An object of the present disclosure is to provide an imaging lens capable of preventing occurrence of unnecessary reflection inside the lens and facilitating assembly of a lens unit.

### SUMMARY

An imaging lens according to the present disclosure includes a lens barrel, and a lens installed in a lens barrel. At least an edge surface of an edge portion on an incident surface side of the lens is formed of a diffusing surface, the edge portion being formed outside an effective diameter of the lens, to surround the lens.

### BRIEF DESCRIPTION OF THE DRAWINGS

FIG. 1 is a sectional view illustrating an example of a configuration of an imaging lens according to an embodiment;

FIG. 2 is a diagram illustrating an edge portion of a lens;

FIG. 3 is a diagram illustrating an antireflection structure of the imaging lens according to the embodiment;

FIG. 4 is a diagram illustrating a behavior of unnecessary reflection caused by backlight entering the lens in FIG. 3;

FIG. 5 is a diagram illustrating an antireflection structure of an imaging lens according to a modification of the embodiment;

FIG. 6 is a diagram illustrating a behavior of unnecessary reflection caused by backlight entering the lens in FIG. 5; and

FIG. 7 is a diagram illustrating a schematic structure of a mold used when manufacturing the imaging lens illustrated in the modification of the embodiment.

### DETAILED DESCRIPTION

Hereinafter, embodiments of an imaging lens according to the present disclosure will be described with reference to the drawings.

Overall Configuration of Imaging Lens

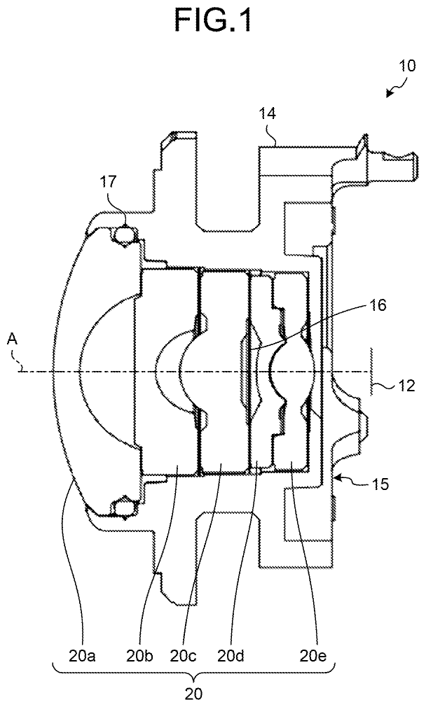

First, an overall configuration of an imaging lens 10 will be described with reference to FIG. 1. FIG. 1 is a sectional view illustrating an example of a configuration of an imaging lens according to an embodiment.

The imaging lens 10 is installed in a vehicle, for example, and forms an image of a vehicle periphery on an imaging element such as a CMOS or a CCD. The formed image is captured by the imaging element and displayed on, for example, a rear view mirror. The image displayed on the rear view mirror notifies a driver of a state behind the vehicle when the vehicle is moved backward. In addition, the captured image is used to detect a road area, presence or absence of any obstacle, and the like in a traveling direction of the vehicle when the vehicle is automatically driven.

The imaging lens 10 holds a plurality of lenses described later in a stacked state on an inner wall of a lens barrel 14. Then, the imaging lens 10 forms an optical image at a position of an imaging element 12. The imaging lens 10 is installed in a housing (not illustrated) that houses the imaging element 12 such that a mount surface 15 formed at a bottom of the lens barrel 14 is positioned at a predetermined distance (flange focal length) from the imaging element 12.

The lens barrel 14 is a cylindrical member that is formed of, for example, resin and holds a lens 20. Inside of the lens barrel 14 is formed of, for example, a mat black material or coated with mat black to prevent reflection of light. A mount surface 15 perpendicular to an optical axis A of the lens held by the lens barrel 14 is formed on a bottom surface of the lens barrel 14.

The lens 20 is designed to have a shape and the number of lenses that satisfy optical specifications such as an angle of view and a focal length, and is molded of resin or glass. The molded lenses 20 are arranged on the inner wall of the lens barrel 14 at predetermined intervals. In the example in FIG. 1, the lens 20 includes five lenses of a first lens 20a, a second lens 20b, a third lens 20c, a fourth lens 20d, and a fifth lens 20e in order from an incident surface side (front surface side). A front surface and a back surface of each lens are formed of spherical or aspherical surfaces.

A diaphragm plate 16 is installed in an intermediate part of the plurality of lenses. The diaphragm plate 16 is a black-coated plate-like member, and is provided with a round hole at a center through which light passes. The diaphragm plate 16 limits a range of light flux passing through the lens 20.

In addition, an O-ring 17 is installed at a contact portion of the first lens 20a and the lens barrel 14. The O-ring 17 prevents moisture, dust, and the like from entering inside the imaging lens 10.

Note that the imaging lens may include a light shielding plate that shields unnecessary light at an intermediate portion of the plurality of lenses.

Edge Portion of Lens

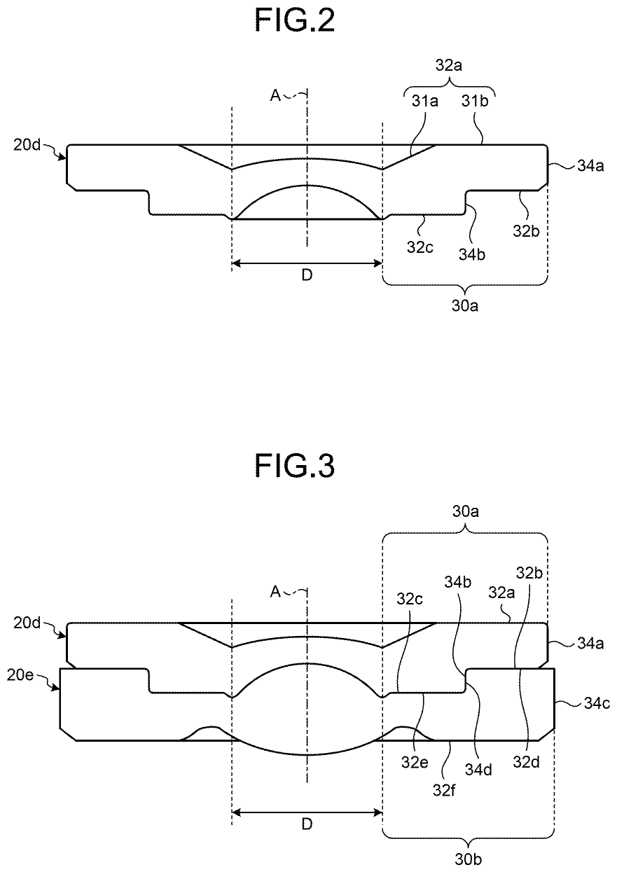

An edge portion of the lens will be described with reference to FIG. 2. FIG. 2 is a diagram illustrating the edge portion of the lens. The lens illustrated in FIG. 2 is the fourth lens 20d in FIG. 1.

As illustrated in FIG. 2, a circular area of an effective diameter D through which a light beam entering from outside passes is formed at a center of the fourth lens 20d. The effective diameter D is a diameter of a light flux parallel to the optical axis A that can be incident on the lens 20 when the lens 20 illustrated in FIG. 1 is formed by combining the plurality of lenses including the fourth lens 20d.

An edge portion 30a surrounding the fourth lens 20d is formed on an outer side (circumference side) of the effective diameter D of the fourth lens 20d. The edge portion 30a is a portion formed to stably hold the fourth lens 20d on the inner wall of the lens barrel 14 and to stably hold the lenses when adjacent lenses are stacked.

The edge portion 30a has a first edge surface 32a, a second edge surface 32b, a third edge surface 32c, a first circumference surface 34a, and a second circumference surface 34b.

The first edge surface 32a is a surface formed on the incident surface side of the edge portion 30a of the fourth lens 20d. When the fourth lens 20d is viewed from the optical axis A direction, the first edge surface 32a forms an annular surface. More specifically, the first edge surface 32a includes an inclined surface 31a formed on the outer side of the effective diameter D of the fourth lens 20d and a horizontal surface 31b substantially orthogonal to the optical axis A.

The second edge surface 32b is a surface formed on the outermost peripheral portion of the edge portion 30a on an exit surface side of the fourth lens 20d, and is substantially orthogonal to the optical axis A. When the fourth lens 20d is viewed from the optical axis A direction, the second edge surface 32b forms an annular surface.

The third edge surface 32c is a surface formed on an inner peripheral side of the second edge surface 32b of the edge portion 30a of the fourth lens 20d, and is substantially orthogonal to the optical axis A. When the fourth lens 20d is viewed from the optical axis A direction, the third edge surface 32c forms an annular surface.

The first circumference surface 34a is a surface formed at a side end of an outer rim of the fourth lens 20d so as to connect the first edge surface 32a and the second edge surface 32b. The first circumference surface 34a forms a cylindrical surface substantially parallel to the optical axis A.

The second circumference surface 34b is a surface formed to connect the second edge surface 32b and the third edge surface 32c. The second circumference surface 34b forms a cylindrical surface substantially parallel to the optical axis A. Although the fourth lens 20d includes the second circumference surface 34b between the second edge surface 32b and the third edge surface 32c, the second circumference surface 34b is a surface formed to stably hold the fourth lens 20d and the fifth lens 20e as described later. Therefore, depending on the lens configuration of the imaging lens 10, the second circumference surface 34b may not be formed on the fourth lens 20d.

Note that, although only the fourth lens 20d has been described here, the other lenses illustrated in FIG. 1 also include a similar edge portion on the outer side of the effective diameter D.

Antireflection Structure of Imaging Lens

An antireflection structure of the imaging lens 10 will be described with reference to FIG. 3. FIG. 3 is a diagram illustrating the antireflection structure of the imaging lens according to the embodiment. In particular, FIG. 3 illustrates only the fourth lens 20d and the fifth lens 20e among the plurality of lenses included in the imaging lens 10.

The fourth lens 20d includes the edge portion 30a illustrated in FIG. 3.

The fifth lens 20e includes an edge portion 30b on the outer side of the effective diameter D of the lens. The edge portion 30b includes a first edge surface 32d and a second edge surface 32e on the incident surface side of the fifth lens 20e. The edge portion 30b includes a third edge surface 32f on the exit surface side of the fifth lens 20e. Furthermore, the edge portion 30b includes a first circumference surface 34c and a second circumference surface 34d.

When the fourth lens 20d and the fifth lens 20e are attached to the lens barrel 14, the second edge surface 32b of the fourth lens 20d and the first edge surface 32d of the fifth lens 20e come into surface contact with each other. The third edge surface 32c of the fourth lens 20d and the second edge surface 32e of the fifth lens 20e are in surface contact with each other. Furthermore, the second circumference surface 34b of the fourth lens 20d and the second circumference surface 34d of the fifth lens 20e are in surface contact with each other. The first circumference surface 34a of the fourth lens 20d and the first circumference surface 34c of the fifth lens 20e are supported by the inner wall of the lens barrel 14. With this configuration, the fourth lens 20d and the fifth lens 20e are firmly supported by the lens barrel 14.

Each surface of the fourth lens 20d forming the edge portion 30a and each surface of the fifth lens 20e forming the edge portion 30b are diffusing surfaces. Specifically, the first edge surface 32a on the incident surface side, the second edge surface 32b and the third edge surface 32c on the exit surface side, the first circumference surface 34a on the circumference side surface side, and the second circumference surface 34b, which form the edge portion 30a of the fourth lens 20d, are sand finish surfaces, and are further painted black by black coating. The sand finish surface is a surface having an irregular texture of sand grains. The sand finish surface forms, for example, a diffuse reflection surface having a surface roughness of about Rz=10 μm. Furthermore, by using the sand finish surface, adhesion between black ink of black coating and the lens is improved. Therefore, for example, even when the imaging lens 10 is left in a high-temperature and high-humidity environment, the ink is prevented from peeling off. Furthermore, since the sand finish surface is painted black, reflectance of visible light is reduced. Thus, light beams entering respective surfaces forming the edge portion 30a of the fourth lens 20d are diffused and reflected.

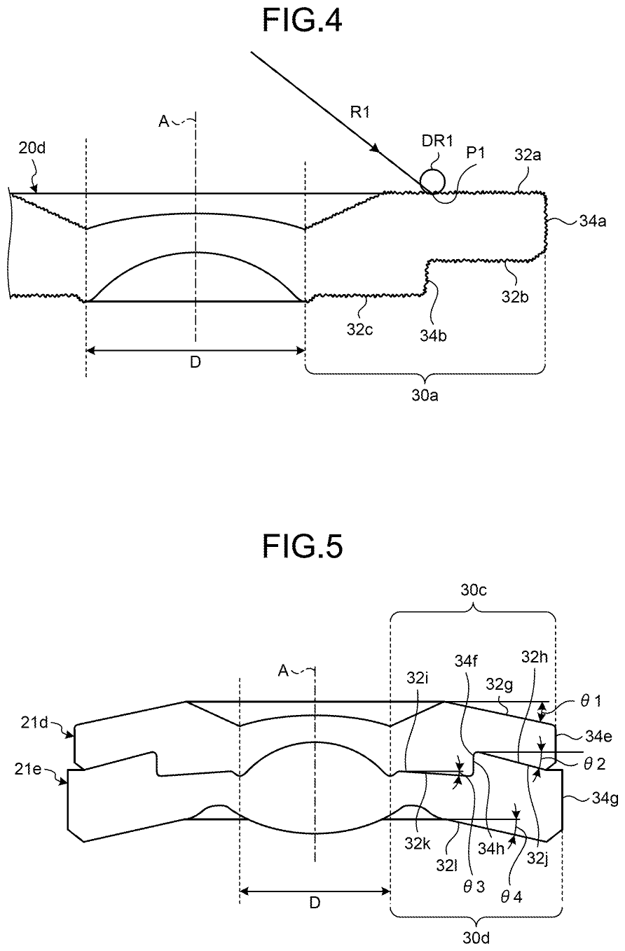

Similarly, each surface forming the edge portion 30b of the fifth lens 20e has a black-painted sand finish surface. By bringing the surfaces forming the edge portion 30a of the fourth lens 20d and the edge portion 30b of the fifth lens 20e into this state, when light not related to imaging enters the edge portion 30a of the fourth lens 20d and the edge portion 30b of the fifth lens 20e, unnecessary reflection at the edge portions 30a and 30b can be reduced. Details will be described later (see FIG. 4).

Note that, although only the fourth lens 20d and the fifth lens 20e included in the imaging lens 10 have been described here, other lenses also have a similar antireflection structure. However, in a case where an effect is confirmed by simulation or the like in advance, the above-described antireflection structure may be applied only to the minimum necessary lens.

Action of Antireflection Structure

An action of the antireflection structure of the imaging lens 10 will be described with reference to FIG. 4. FIG. 4 is a diagram illustrating a behavior of unnecessary reflection caused by backlight entering the lens in FIG. 3. In order to simplify the description, only the incident surface of the fourth lens 20d will be described here.

Light beams entering within a range of the effective diameter D of the imaging lens 10 travel while being repeatedly refracted by the plurality of lenses included in the imaging lens 10, and form an image on the imaging element 12. On the other hand, light beams traveling outside the effective diameter D of the imaging lens 10 reach the edge portion of the lens.

A light beam R1 illustrated in FIG. 4 is an example of a light beam traveling outside the effective diameter D of the imaging lens 10. The light beam R1 reaches the first edge surface 32a on the incident surface side of the fourth lens 20d at a point P1. Since the first edge surface 32a is a black painted diffusing surface as described above, the light beam R1 cannot enter inside the fourth lens 20d at the point P1. Since the first edge surface 32a is painted black, an intensity of the reflected light of the light beam R1 is reduced by reducing reflectance. Furthermore, since the first edge surface 32a is the diffusing surface, the light beam R1 is diffused and reflected by a reflection intensity distribution DR1 at the point P1. The reflection intensity distribution DR1 indicates that the light beam R1 is diffused and reflected with substantially equal intensity in all directions on the incident surface side of the first edge surface 32a. In other words, the intensity of the light beam R1 that has reached the first edge surface 32a is attenuated at the black-painted first edge surface 32a. In the light beam R1, the light beam diffused and reflected at the first edge surface 32a is uniformly diffused in substantially all directions. Therefore, incidence of the light beam R1 into the fourth lens 20d is suppressed.

With this antireflection structure, even when strong backlight is incident on the edge portion 30a of the imaging lens 10, generation of unnecessary reflection inside the lens due to the backlight is suppressed, and thus generation of stray light is suppressed. As a result, occurrence of ghost and flare is suppressed.

Note that the above-described antireflection measure may be applied to at least the first edge surface 32a on the incident surface side of the fourth lens 20d. However, in order to reduce unnecessary reflection due to the light beam that has entered inside the fourth lens 20d and is not related to image formation, a similar antireflection measure may be taken for the second edge surface 32b and the third edge surface 32c on the exit surface side of the fourth lens 20d, the first circumference surface 34a, and the second circumference surface 34b.

### Effect of Embodiment

As described above, in the imaging lens 10 of the present embodiment, at least the first edge surface 32a on the incident surface side of the fourth lens 20d, in the edge portion 30a formed so as to surround the fourth lens 20d on the outer side of the effective diameter D of the fourth lens 20d installed in the lens barrel 14, is formed of the diffusing surface. Therefore, the occurrence of unnecessary reflection inside the lens can be prevented, and the lens unit can be easily assembled.

Furthermore, in the imaging lens 10 of the present embodiment, the second edge surface 32b and the third edge surface 32c on the exit surface side of the fourth lens 20d in the edge portion 30a of the fourth lens 20d are further formed of diffusing surfaces. Therefore, the occurrence of unnecessary reflection inside the lens can be further prevented.

Furthermore, in the imaging lens 10 of the present embodiment, the first circumference surface 34a and the second circumference surface 34b of the fourth lens 20d in the edge portion 30a of the fourth lens 20d are further formed of diffusing surfaces. Therefore, the occurrence of unnecessary reflection inside the lens can be further prevented.

Furthermore, in the imaging lens 10 of the present embodiment, the diffusing surface formed on the edge portion 30a of the fourth lens 20d is the sand finish surface. Therefore, it is possible to prevent the light beam reaching the edge portion 30a of the fourth lens 20d from traveling into the fourth lens 20d. As a result, unnecessary reflection inside the fourth lens 20d can be prevented.

Furthermore, in the imaging lens 10 of the present embodiment, coating reducing the reflectance is applied to the diffusing surface formed in the edge portion 30a of the fourth lens 20d. Therefore, the reflectance at the edge portion 30a of the fourth lens 20d can be reduced.

Furthermore, in the imaging lens 10 of the present embodiment, the coating applied to the edge portion 30a of the fourth lens 20d is black coating. Therefore, the reflectance at the edge portion 30a of the fourth lens 20d can be more reliably reduced.

### Modification of Embodiment

Next, a modification of the embodiment will be described. An imaging lens 10 illustrated in the present modification includes a further antireflection structure in addition to the above-described antireflection structure.

Antireflection Structure of Imaging Lens

Another antireflection structure of the imaging lens 10 will be described with reference to FIG. 5. FIG. 5 is a diagram illustrating the antireflection structure of the imaging lens according to the modification of the embodiment. In particular, FIG. 5 illustrates only a fourth lens 21d and a fifth lens 21e among the plurality of lenses included in the imaging lens 10.

The fourth lens 21d includes an edge portion 30c on an outer side of an effective diameter D of the lens.

The edge portion 30c includes a first edge surface 32g on the incident surface side of the fourth lens 21d. The edge portion 30c includes a second edge surface 32h and a third edge surface 32i on the exit surface side of the fourth lens 21d. Furthermore, the edge portion 30c includes a first circumference surface 34e and a second circumference surface 34f.

When the fourth lens 21d is viewed from the incident surface side, an end of the first edge surface 32g on the optical axis A side is located nearer (in front) than an end on the circumference side. In other words, a normal line of the first edge surface 32g is not parallel to the optical axis A and faces a direction abutting on the inner wall of the lens barrel 14 on the incident surface side of the fourth lens 21d. In other words, the first edge surface 32g is formed to be inclined by an angle θ1 as illustrated in FIG. 5. A value of the angle θ1 is set according to a reduction level of stray light, and is, for example, about 1 to 8°.

In addition, the normal line of the second edge surface 32h and the normal line of the third edge surface 32i are not parallel to the optical axis A and face a direction abutting on the inner wall of the lens barrel 14 on the incident surface side of the fourth lens 21d. In other words, the second edge surface 32h is formed to be inclined by an angle θ2 as illustrated in FIG. 5. The third edge surface 32i is formed to be inclined by an angle θ3 as illustrated in FIG. 5. Values of the angles θ2 and 03 are set according to the reduction level of stray light, and are, for example, about 1 to 8°.

Note that the first circumference surface 34e and the second circumference surface 34f included in the fourth lens 21d form a cylindrical surface substantially parallel to the optical axis A.

The fifth lens 21e includes an edge portion 30d on the outer side of the effective diameter D of the lens.

The edge portion 30d includes a first edge surface 32j and a second edge surface 32k on the incident surface side of the fifth lens 21e. The edge portion 30d includes a third edge surface 32l on the exit surface side of the fifth lens 21e. Furthermore, the edge portion 30d includes a first circumference surface 34g and a second circumference surface 34h.

When the fifth lens 21e is viewed from the incident surface side, ends of the first edge surface 32j and the second edge surface 32k on the optical axis A side are located nearer (in front) than ends on the circumference side. In other words, the normal lines of the first edge surface 32j and the second edge surface 32k are not parallel to the optical axis A, and face a direction abutting on the inner wall of the lens barrel 14 on the incident surface side of the fifth lens 21e. In other words, the first edge surface 32j is formed to be inclined by the angle θ2 as illustrated in FIG. 5. The second edge surface 32k is formed to be inclined by the angle θ3 as illustrated in FIG. 5.

Values of the angles θ2 and 03 are set according to the reduction level of stray light, and are, for example, about 1 to 8°.

In addition, the normal line of the third edge surface 32l is also not parallel to the optical axis A, and faces a direction abutting on the inner wall of the lens barrel 14 on the incident surface side of the fifth lens 21e. In other words, the third edge surface 32l is formed to be inclined by an angle θ4 as illustrated in FIG. 5. A value of the angle θ4 is set according to the reduction level of stray light, and is, for example, about 1 to 8°.

Note that the first circumference surface 34g and the second circumference surface 34h included in the fifth lens 21e form a cylindrical surface substantially parallel to the optical axis A.

Action of Antireflection Structure

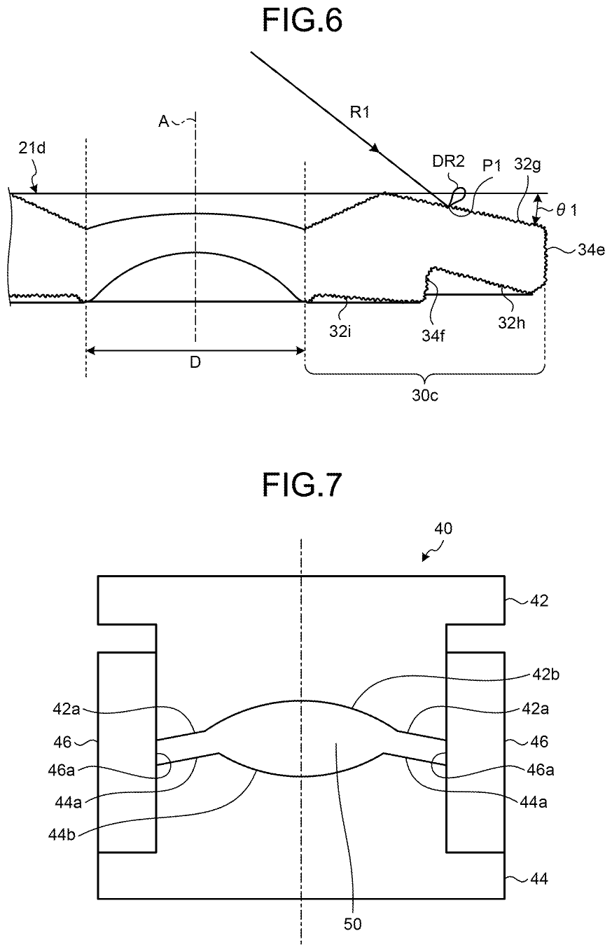

An action of the antireflection structure will be described with reference to FIG. 6. FIG. 6 is a diagram illustrating a behavior of unnecessary reflection caused by backlight incident on the imaging lens in FIG. 5. In order to simplify the description, only the incident surface of the fourth lens 21d will be described here.

Light beams entering within a range of the effective diameter D of the imaging lens 10 travel while being repeatedly refracted by the plurality of lenses included in the imaging lens 10, and form an image on the imaging element 12. On the other hand, light beams traveling outside the effective diameter D of the imaging lens 10 reach the edge portion of the lens.

The light beam R1 illustrated in FIG. 6 is an example of a light beam traveling outside the effective diameter D of the imaging lens 10. A light beam R1 reaches the first edge surface 32g on the incident surface side of the fourth lens 21d at a point P1. Since the first edge surface 32g is a black painted diffusing surface as described above, the light beam R1 cannot enter inside the fourth lens 21d at the point P1. Since the first edge surface 32g is painted black, an intensity of reflected light of the light beam R1 is reduced by reducing the reflectance. Furthermore, since the first edge surface 32g is the diffusing surface, the light beam R1 is diffused and reflected by a reflection intensity distribution DR2 at the point P1. Here, since the normal direction of the first edge surface 32g faces a direction abutting on the inner wall of the lens barrel 14 on the incident surface side of the fourth lens 21d, the reflection intensity distribution DR2 has a strong reflection intensity in a direction toward the inner wall of the lens barrel 14. In other words, the intensity of the light beam R1 that has reached the first edge surface 32g attenuates on the black-painted first edge surface 32g. In the light beam R1, most of components diffused and reflected on the first edge surface 32g are directed toward the inner wall of the lens barrel 14. Therefore, incidence of the light beam R1 into the fourth lens 21d is suppressed.

With this antireflection structure, even when strong backlight enters the edge portion 30c of the imaging lens 10, the occurrence of unnecessary reflection inside the lens due to the backlight is suppressed, and thus the occurrence of stray light is suppressed. As a result, occurrence of ghost and flare is suppressed.

Lens Manufacturing Method

A method of manufacturing a lens configuring the imaging lens 10 described in the modification of the present embodiment will be described with reference to FIG. 7. FIG. 7 is a diagram illustrating a schematic structure of a mold used when manufacturing the imaging lens illustrated in the modification of the present embodiment.

In the case of a resin lens, the lens configuring the imaging lens 10 is manufactured by pouring resin into a mold 40 and pressing the mold 40. In addition, in the case of a glass mold lens, a glass material is placed in the mold 40, heated, and softened, and then the mold 40 is pressed to manufacture the glass mold lens.

The mold 40 includes an upper mold 42, a lower mold 44, and a body mold 46.

The upper mold 42 forms the incident surface of the lens. On a mold surface of the upper mold 42, mold surfaces respectively corresponding to an edge surface 42a and a lens incident surface 42b are formed. The mold surface corresponding to the edge surface 42a is formed as a rough surface. The mold surface corresponding to the lens incident surface 42b is formed as a mirrored surface forming a spherical surface or an aspherical surface having a predetermined curvature.

The lower mold 44 forms the exit surface of the lens. On the mold surface of the lower mold 44, mold surfaces respectively corresponding to an edge surface 44a and a lens exit surface 44b are formed. The mold surface corresponding to the edge surface 44a is formed as the rough surface. The mold surface corresponding to the lens exit surface 44b is formed as a mirrored surface forming a spherical surface or an aspherical surface having a predetermined curvature.

The body mold 46 prevents positional deviation when the upper mold 42 and the lower mold 44 are pressed, and forms the circumference surface of the lens. A mold surface of the body mold 46 corresponding to a circumference surface 46a is formed as the rough surface.

When the upper mold 42, the lower mold 44, and the body mold 46 are combined, a space 50 surrounded by the mold surfaces of the respective molds is formed. A resin material of the resin lens or a glass material of the glass mold lens is pressed by the upper mold 42, the lower mold 44, and the body mold 46 in the space 50, thereby manufacturing the lens. Then, the mold surfaces formed by the rough surfaces of the upper mold 42, the lower mold 44, and the body mold 46 are transferred to the edge surface 42a, the edge surface 44a, and the circumference surface 46a, respectively. On the other hand, the mold surfaces corresponding to the lens surfaces of the upper mold 42 and the lower mold 44 are transferred to the lens incident surface 42b and the lens exit surface 44b, respectively.

Note that, although not illustrated, the lens (e.g., fourth lens 20d in FIG. 2) configuring the imaging lens 10 as described in the embodiment of the present embodiment is also manufactured by a mold having a structure similar to that in FIG. 7. In this case, the edge surface 42a and the edge surface 44a are horizontal surfaces with no inclination.

### Effect of Modification of Embodiment

As described above, in the imaging lens 10 according to the modification of the present embodiment, the first edge surface 32g of the fourth lens 21d is formed in such a direction that the light beam reaching the first edge surface 32g from outside the fourth lens 21d is diffused and reflected more strongly in the direction toward the inner wall of the lens barrel 14. Therefore, the occurrence of unnecessary reflection inside the lens can be prevented.

Furthermore, in the imaging lens 10 according to the modification of the present embodiment, the fourth lens 21d is manufactured, for example, using the mold in which the mold surface corresponding to the edge portion 30c of the fourth lens 21d is formed as the rough surface. Therefore, the lens in which the edge surface and the circumference surface are formed of the diffusing surfaces can be reliably and easily manufactured.

According to the imaging lens of the present disclosure, unnecessary reflection inside the lens can be prevented, and the lens unit can be easily assembled.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging lens comprising a lens installed in a lens barrel, wherein
at least an edge surface of an edge portion on an incident surface side of the lens is formed of a diffusing surface, the edge portion being formed outside an effective diameter of the lens, to surround the lens.

2. The imaging lens according to claim 1, wherein an edge surface of the edge portion on an exit surface side of the lens is further formed of the diffusing surface.

3. The imaging lens according to claim 1, wherein a circumference surface of the edge portion of the lens is further formed of the diffusing surface.

4. The imaging lens according to claim 1, wherein the edge surface is formed in such a direction that a light beam reaching the edge surface from outside the lens is diffused and reflected more strongly in a direction toward an inner wall of the lens barrel.

5. The imaging lens according to claim 1, wherein the diffusing surface is a sand finish surface.

6. The imaging lens according to claim 1, wherein the lens is manufactured using a mold having a mold surface corresponding to the edge portion of the lens and being formed of a rough surface.

7. The imaging lens according to claim 1, wherein coating reducing reflectance is applied to the diffusing surface formed on the edge portion of the lens.

8. The imaging lens according to claim 7, wherein the coating is black coating.
